(19) United States
(12) Patent Application Publication
(10) Pub. No.: US 2025/0229835 A1
(43) Pub. Date: Jul. 17, 2025

(54) FRONT RAIL WITH CRASH TUNING FEATURES

(71) Applicant: Shape Corp., Grand Haven, MI (US)

(72) Inventors: Jeffrey A. McHenry, Norton Shores, MI (US); Ed Pleet, Novi, MI (US); Joseph R. Matecki, Allendale, MI (US)

(73) Assignee: Shape Corp., Grand Haven, MI (US)

(21) Appl. No.: 19/024,935

(22) Filed: Jan. 16, 2025

Related U.S. Application Data
(60) Provisional application No. 63/621,827, filed on Jan. 17, 2024.

(51) Int. Cl. B62D 21/15

(52) U.S. Cl. CPC B62D 21/152

(57) ABSTRACT

A front rail configured to be supported by a vehicle frame includes a tubular body formed by a roll-formed high-strength metal and configured to undergo axial loading during a front vehicle impact. The high-strength metal defines a cross-section shape along the length of the tubular body. The tubular body includes at least one crash tuning feature located on the tubular body. The tubular body is configured to undergo axial loading during a frontal vehicle impact and under said impact, the tubular body is configured to deform at the at least one crash tuning features.

### CROSS-REFERENCE TO RELATED APPLICATION

This application claims the benefit and priority under 35 U.S.C. § 119 (e) of U.S. provisional application Ser. No. 63/621,827, filed on Jan. 17, 2024, the content of which is incorporated herein by reference in its entirety.

### TECHNICAL FIELD

The present disclosure relates to vehicle frame assemblies and more specifically to front rail forms and assemblies for vehicle body structures.

### BACKGROUND

Vehicle frames and body structures are designed to support the vehicle and undergo and absorb certain levels of impact forces, such as to prevent distances of inboard intrusion into the vehicle in accordance with insurance requirements and other regulatory and legal requirements. Front impacts to a vehicle are commonly tested with front end impact testing, which direct significant impact forces to the front of the vehicle. Vehicle frames primarily absorb these front impacts via front rails and front rail assemblies that run longitudinally between the front bumper and vehicle cab.

It is desirable for the front impact forces to be converted into other forms of energy in a predictable and controllable manner. In order to achieve the goals of crashworthiness, light weight, and efficient material usage, improved forms for front rails are desirable. In a transition toward electric vehicles, the presence of the engine in the front portion of the vehicle is no longer a given in vehicle design. Therefore, front rails will be increasingly critical in absorbing front impact energy in a predictable and controlled manner, and opportunities exist to provide improved front rail and front rail assemblies.

### SUMMARY

The present disclosure provides a vehicle front rail that absorbs front impact energy in a predictable and controlled manner. The front rail may include a high-strength metal sheet or other rigid material extending longitudinally along a length to form a tubular beam. The tubular beam may direct longitudinal forces between a bumper assembly and a mid-frame assembly at opposing ends of the tubular beam. The tubular beam may have a generally constant cross-sectional shape and area along its length. Alternatively, the tubular beam may have a substantially constant cross-sectional shape and area along its length.

The front rail may be formed of a single continuous piece of material, such as a sheet material that is formed via roll-forming, stamping, or a combination thereof. In some examples, the front rail may be formed of a sheet material having multiple thicknesses along the length of the material. In other examples, the front rail may be formed of a sheet having multiple materials along the length of the material. The front rail may be formed to have a substantially rectangular cross-sectional shape. The cross-sectional shape may define an enclosed shape having a first side wall portion, a second side wall portion, a top wall portion, and a bottom wall portion.

The front rail may have at least one crash-tuning feature on the metal sheet. The crash-tuning feature may be configured to undergo deformation during axial loading in a frontal vehicle impact between the front and rear ends of the tubular beam. The front rail may have a plurality of crash-tuning features along the length of the tubular beam. The tubular beam may include a plurality of apertures along the length of the beam. The apertures may extend through the sheet material from an outer surface to the inner surface. The apertures may include a flange around the circumference of the aperture on the inner surface. The flange may extend into the cross-sectional shape at the aperture locations. The plurality of apertures may be aligned in vertical lines along the first or second side wall portions. The vertical line of apertures may be positioned proximate the front end of the tubular beam.

The tubular beam may include at least one curved region along the length of the beam. The at least one curved region may comprise at least one of an outboard curve or an inboard curve. In some examples, the curved region may include an outboard curve and an inboard curve. The tubular beam may include at least one reinforcement bracket. The reinforcement bracket may be positioned in an outer corner or an inner corner of the cross-sectional shape. The reinforcement bracket may be positioned in a designated location along the length of the beam. In other examples, the bracket may extend along the length of the beam. The reinforcement bracket may also be configured as a flange extending off the cross-sectional shape of the beam. The tubular beam may consist of more than one reinforcement bracket. The tubular beam may include a plurality of weld spots along the length of the beam. The weld spots may be located on the outer surface of the sheet metal of the beam. The weld spots may be in parallel lines along a front end of the beam. In other examples, the weld spots may be positioned on opposing sides of the beam in an alternating arrangement.

The disclosure provides a structural beam for a vehicle that includes an elongated body formed from a metal sheet material and configured to extend from a first end at a bumper assembly to a second end at a mid-frame assembly. The elongated body may include a plurality of crash tuning areas formed along the sheet materials which define areas of reduced strength of the elongated body. The crash tuning areas are configured to undergo deformation during axial loading in a frontal vehicle impact between the first end and the second end of the elongated body.

The disclosure provides a front rail configured to be supported by a vehicle frame having a tubular body formed by a roll-formed high-strength metal and defining a cross-sectional shape along a length of the tubular body and at least one crash tuning feature located on the tubular body. The tubular body is configured to undergo axial loading during a frontal vehicle impact and deform at the at least one crash tuning features. The crash-tuning features may include a plurality of apertures in the high-strength metal having a flange around the circumference of the aperture on an inner surface of the high-strength metal. The crash-tuning features may include a curve in the tubular body. The crash-tuning features may include a plurality of designated locations along the tubular body where the high-strength metal has been weakened by at least one of a thinning of the metal, heating of the metal, or welding of the metal at said locations.

Implementations of the disclosure may include one or more of the preceding features in various combinations.

### BRIEF DESCRIPTION OF THE DRAWINGS

FIG. 1 is a side elevation view of a vehicle showing a front rail extending between a bumper assembly and a vehicle frame component proximate a passenger cabin.

FIG. 2 is a perspective view of a partial vehicle frame including a pair of front rails extending between attachment plates of a vehicle bumper assembly and a vehicle frame component proximate a passenger cabin.

FIG. 3 is a perspective view of an exemplary front rail.

FIG. 4 is a cross-sectional view of the front rail taken at line IV-IV shown in FIG. 3.

FIG. 5 is a perspective view of an exemplary front rail having a first exemplary crash tuning feature.

FIG. 6 is a cross-sectional view of the front rail taken at line VI-VI shown in FIG. 5.

FIG. 7 is a perspective view of an exemplary front rail having a second exemplary crash tuning feature.

FIG. 8 is a cross-sectional view of the front rail taken at line VIII-VIII shown in FIG. 7.

FIG. 9 is a perspective view of an exemplary front rail having a third exemplary crash tuning feature.

FIG. 10A is a top view of an exemplary front rail having a fourth exemplary crash tuning feature.

FIG. 10B is a top view of an exemplary front rail having a fifth exemplary crash tuning feature.

FIG. 11 is a perspective view of an exemplary front rail having a sixth exemplary crash tuning feature.

FIG. 12 is a cross-sectional view of the front rail taken at line XII-XII shown in FIG. 11.

FIG. 13 is a perspective view of an exemplary front rail having a seventh exemplary crash tuning feature.

FIG. 14 is a perspective view of an exemplary front rail having an eighth exemplary crash tuning feature.

FIG. 15 is a perspective view of an exemplary front rail having a plurality of exemplary crash tuning features.

FIG. 16 is a cross-sectional view of the front rail taken at line XVI-XVI shown in FIG. 15.

The details of one or more examples of the disclosure are set forth in the accompanying drawings and the description below. Other aspects, advantages, purposes, and features will be apparent upon review of the following specification in conjunction with the drawings, where like reference numerals indicate like parts.

### DETAILED DESCRIPTION

Structural frames and assemblies for vehicle structures, such as a vehicle front rail, are disclosed herein in various implementations as impact energy absorption and management devices that are used in conjunction with other vehicle components to absorb and manage impact loads and energy, so as to minimize damage and intrusion during an impact to the vehicle. For example, a structural beam may be employed between a bumper assembly and a mid-frame assembly. In some instances, vehicle assemblies may have increased front end stiffness and impact energy absorption requirements, such as on electric vehicles or rear engine mounted vehicles with greater vehicle mass and front ends that may be more susceptible to impact intrusion. While it is generally known that front rail beams with increased mass can function to meet increased stiffness requirements, increasing mass typically adds to the vehicle cost while also reducing efficiency. Structural beams disclosed herein may provide increased stiffness being formed, for example by roll-forming, of a single sheet of metal or other rigid material with crashworthy mechanisms for converting impact forces into other forms of energy in predictable and controlled manners.

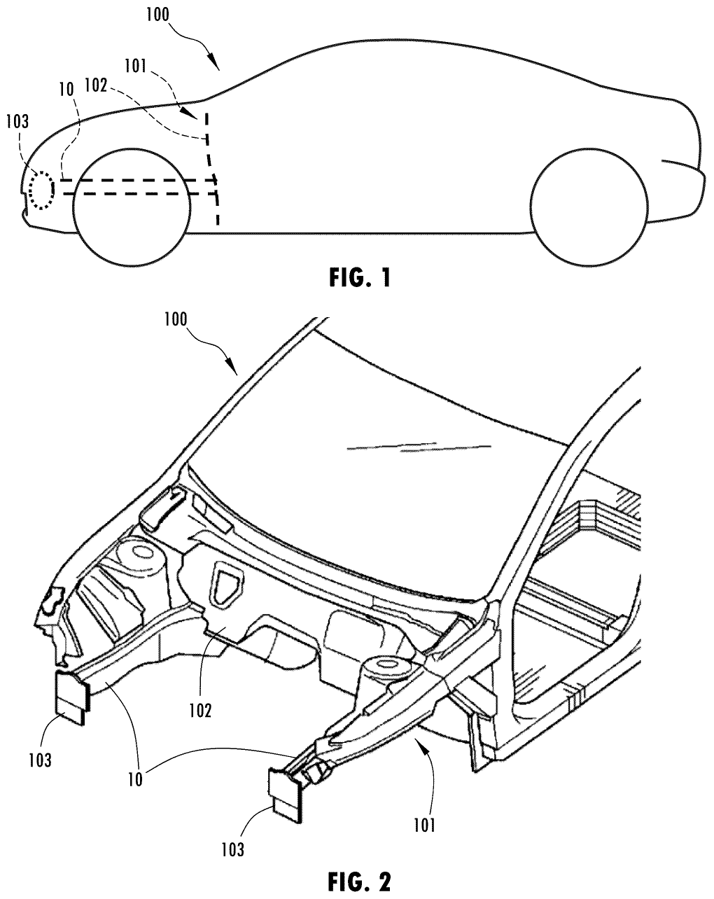

Referring now to the drawings and the illustrative embodiments depicted therein, a front rail 10 is provided for a vehicle 100, such as for a body structure or frame 101, such as illustrated in FIGS. 1 and 2. The vehicle frame 101 and associated components may have various designs and configurations, such as for different styles and types of vehicles. As shown in FIGS. 1 and 2, the vehicle frame 101 may include a mid-frame assembly or firewall 102 and a bumper assembly 103, among other vehicle frame components. The front rail 10 may be used as a structural frame component designed to undergo various impact forces and designed to support and sustain different loading conditions. While designing the vehicle to meet the required impact and loading requirements, the dimensions of the front rail 10 component may be reduced and the overall weight of the front rail 10 may be reduced by providing a front rail 10 of the present disclosure. The vehicle 100 may include a pair of front rails 10 bracketing a front engine compartment. The vehicle 100 may not include a propulsion system having an internal combustion engine, and so the front engine compartment may be a front storage compartment. The front rail 10 may extend at least a portion of the distance between a front bumper assembly 103 and a firewall 102 or another structural component of the vehicle frame 101.

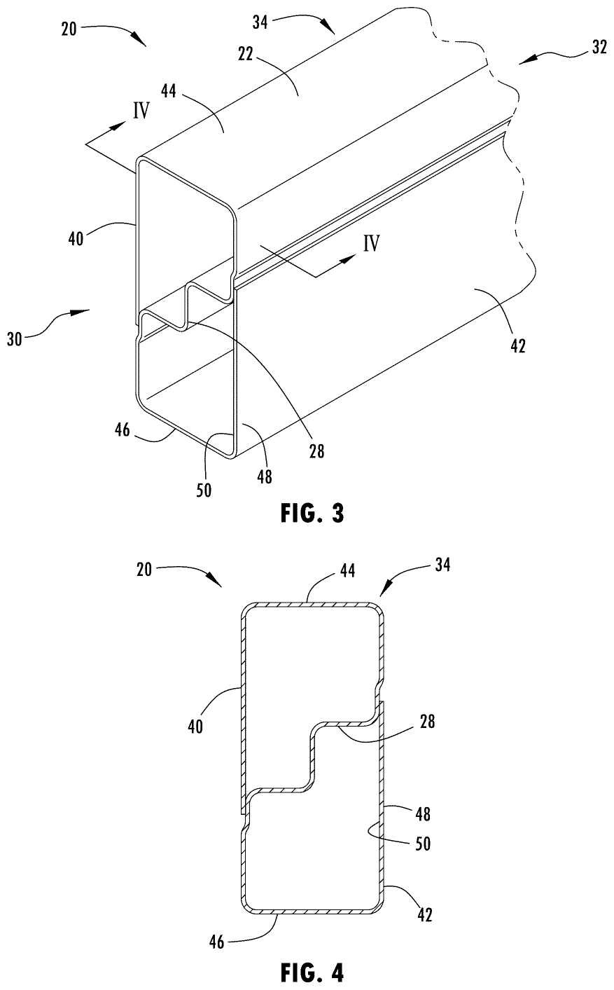

Referring to FIGS. 3 and 4, an exemplary front rail 20 is shown. The front rail 20 is a roll-formed structural element formed of a single piece of a thin sheet material 22. The rail 20 includes a closed cross-sectional shape. The rail 20 profile defines an elongated body or tubular beam 34 which is defined by a first side wall portion 40, a second side wall portion 42, a top wall portion 44, and a bottom wall portion 46. The first side wall portion 40 is located inboard relative to the second side wall portion 42 or may be reversed to be located outboard relative to the second side wall portion in additional examples of the rail. The first side wall portion 40 and first side wall portion 42 are connected by the top wall portion 44 and the bottom wall portion 46. A leading edge or front end 30 of the beam 34 is configured to couple with the bumper assembly 103 or another vehicle frame component. A rear end 32, opposite the first end 30, is configured to couple to a mid-frame component such as a firewall 102 or another vehicle frame component. The cross-sectional shape of the elongated body 34 extends along a length of the body 34 from the front end 30 to the rear end 32. The elongated body 34 also includes a central wall 28 extending longitudinally along the length of the body 34, such that the cross-sectional shape includes a plurality of hollow channels defined by the central wall 28. As shown in FIGS. 3 and 4, the central wall 28 extends, in some examples, from a first vertical location on the first side wall portion 40 to a second vertical location on the second side wall portion 42. Alternatively, the cross-sectional shape may have more or less channels.

The metal sheet material 22 of the structural beam 34 may comprise any metals or metal alloys that have the desired characteristics, such as stiffness, tensile strength, and the like. For example, the material may include aluminum or steel, such as a high strength or ultra-high strength steel, as well as combinations of other related metals in different alloys. The sheet material may be entirely or partial a non-sheet material, such as an injection molded polymer, a composite, an aluminum extrusion, or a composite pultrusion, or the like. The sheet material of the outer beam profile 20 may be formed in various processes, such as with the use of cold stamping, roll forming, roll stamping, hot stamping, press brake bending, or combinations thereof. References herein to a particular forming process should be understood as non-limiting. Selection of the appropriate forming process for a particular material and application of the presently disclosed structural beam 34 may be understood as within the level of ordinary skill.

The front rail may include at least one of a plurality of crash tuning features. The crash tuning features are configured to convert impact forces into other forms of energy in predictable and controlled manners to reduce damage and intrusion during impact. For example, the crash tuning features may be configured to cause longitudinal or axial impact forces, such as a result of front end collisions, to deform the front rail and cause or initiate controlled lateral bending, such as select locations along the length of the front rail. Examples of the plurality of crash tuning features are described below separately and in different combinations.

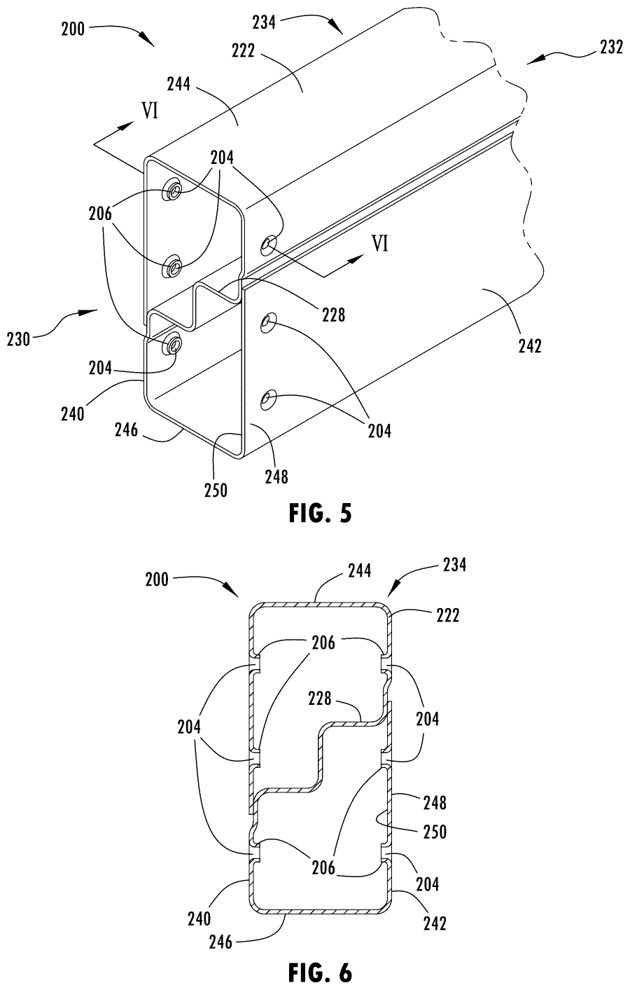

Referring to FIGS. 5 and 6, an exemplary front rail 200 is shown having a first exemplary crash tuning feature, namely, pre-pierced holes. The first exemplary crash tuning feature is configured as an aperture 204. The aperture 204 comprises a hole or void in the sheet material 22, extending from an outer wall or surface 48 of the sheet material 22 to the inner wall or surface 50 of the sheet material 22. The aperture 204 comprises a flange 206 surrounding the circumference of the aperture 204 on the inner wall or surface 50 of the sheet material 22. The flange 206 extends inward into the hollow volume of the cross-sectional shape of the rail 200.

The rail 200 may include a plurality of apertures 204 along the surface of the rail. For example, as shown in FIGS. 5 and 6, the plurality of apertures 204 are positioned along a vertical line B1 on a sidewall of the front rail 200. The vertically aligned apertures together may form an effective bend initiation line B1, such that axial forces cause failure along the bend initiation line B1 that results in a controlled bending failure of the beam that has a desired force deflection characteristic and a desired location of bending the beam. Alternatively, additional apertures may be positioned along the body at various locations that do not correspond to a bend initiation line but otherwise are in areas that promote desired deformation characteristics of the beam.

The flange 206 provides additional sheet material 22 at the aperture 204 to increase the stretchability of the material 22 at the aperture 204, such that during bending, the flange 206 reduces strain along the circumference of the aperture 204 to prevent or reduce tearing and/or further compromising the aperture 204. The apertures 204 with the flange 206 may be pre-pierced, such that the sheet material 22 is pierced to form the apertures 204 prior to roll-forming the rail. Alternatively, the apertures may be pierced post-forming the rail.

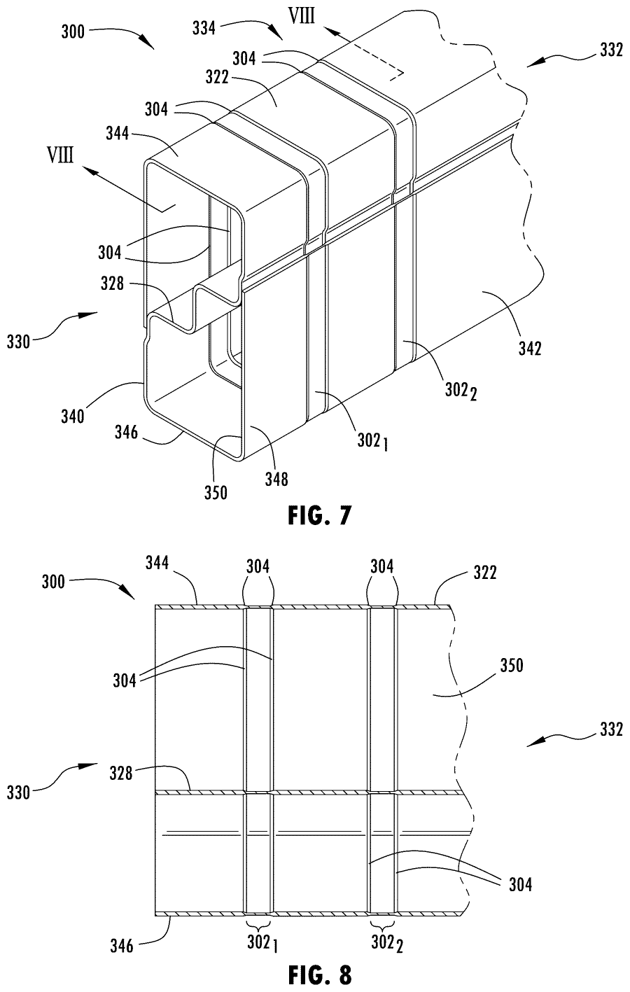

Referring to FIGS. 7 and 8, an exemplary front rail 300 is shown having a second exemplary crash tuning feature, namely, varying thicknesses defined by a tailor rolled blank. The second exemplary crash tuning feature has the front rail 300 formed from sheet material 322 including different thicknesses or materials along the length of the front rail 300. For example, the rail 300 may include a plurality of localized areas 302x (e.g., 3021, 3022) where the sheet material 322 in the localized area differs from the sheet material generally along the length of the rail 300. The localized areas 302x may be positioned along a leading edge 330 of the rail 300 in parallel lines, such as illustrated in FIGS. 7 and 8. In other examples, the localized areas may be positioned in other positions along the rail to provide for desired deformation locations in the beam. For example, localized areas may be in an alternating formation along the length of the rail to allow for a z-shaped buckle of the beam under impact forces.

The localized areas 302x may consist of sheet material exhibiting different stresses and demands to cause deformations such as buckling or bending at the localized areas 302x. For example, the localized areas 302x may have a second material thickness which is thinner than a first material thickness of the sheet material 322 generally along the length of the rail 300 not in the localized areas. The sheet material 322 includes linear, smooth transitions between the different thicknesses to reduce stress peaks at the transition lines 304.

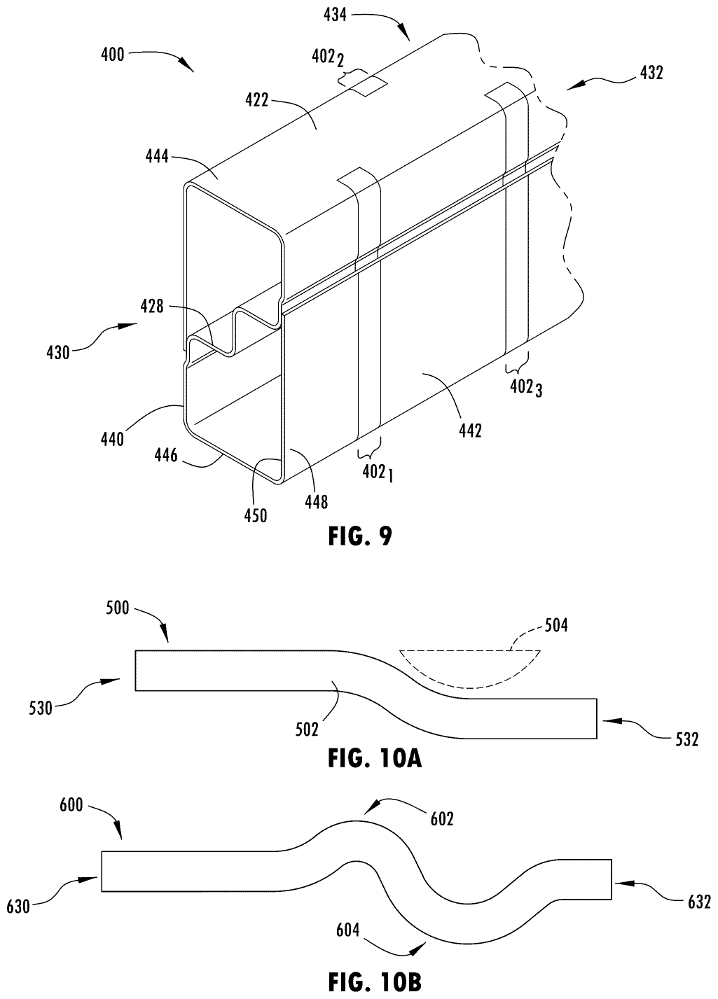

Referring to FIG. 9, an exemplary front rail 400 is shown having a third exemplary crash tuning feature, namely, varying hardness defined by localized annealing. The third crash tuning feature includes the rail 400 formed from a sheet material 422 comprising a plurality of localized areas 402x (e.g., 4021, 4022, 4023) where the sheet material 422 has undergone localized annealing in-line with the roll-forming process. For example, the localized areas 402x undergo heat treatments, which raise the temperature of the sheet material 422 to about its recrystallization temperature, but below its melting point. As a result, the localized areas 402x have decreased hardness and increase ductility which result in increased buckling at the localized areas 402x under certain impact forces. The localized areas 402x may be positioned at alternating sidewalls in spaced locations along the length to provide a controlled buckling deformation, such as shown in FIG. 9. Also, the localized areas 402x may be positioned in an alternating formation along the length of the rail to allow for a z-shaped buckling of the beam under impact forces. In other examples, the localized areas may be positioned in other areas along the length of the rail to provide for designed deformation location in the beam. For example, the localized areas may be positioned along a leading edge in parallel lines to provide a crushing deformation under certain impact forces.

Referring to FIGS. 10A and 10B, exemplary front rails 500, 600 are shown having additional examples of crash tuning features that include curved shapes formed by in-line sweeping of the rail. The fourth crash tuning feature comprises in-line sweeping of the rail 500 to create a curved shape along the length of the rail. As illustrated in FIG. 10A, the rail 500 may have a generally straight configuration adjacent a leading edge 530 where the rail 500 is attached to a bumper assembly (not shown). Approximate the rear edge 532 where the rail 500 may attach to a firewall (not shown), the rail 500 may include a curved configuration 502 where the rail 500 is swept inboard of the vehicle. This curved configuration 502 may be provided to better fit the rail 500 around other necessary portions of the vehicle. For example, in this configuration, the rail 500 may be designed to sweep further inboard from a wheel well 504 to allow tighter wheel turns without a wheel interfering with the front rail 500.

As illustrated in FIG. 10B, the rail 600 has a fifth exemplary crash tuning feature with in-line sweeping of the rail 600 creating a curved shape to the rail may have a generally straight configuration adjacent to the leading edge 630. Approximate the rear edge 632, the rail 600 may include a double curved configuration wherein the rail is first swept outboard before being swept inboard of the vehicle. As shown in FIG. 10B, an outboard curve 602 is positioned closest to the leading edge with the inboard curve 604 positioned rearward of the outboard curve 602. The double curved configuration may provide better clearance as described in relation to FIG. 10A, as well as provide a bend initiation location for desired deformation. For example, the double curved configuration may cause reduced strength along the rail 600 at the curves 602, 604, thereby forcing deformation and bending to occur at the curves 602, 604 under certain impact forces.

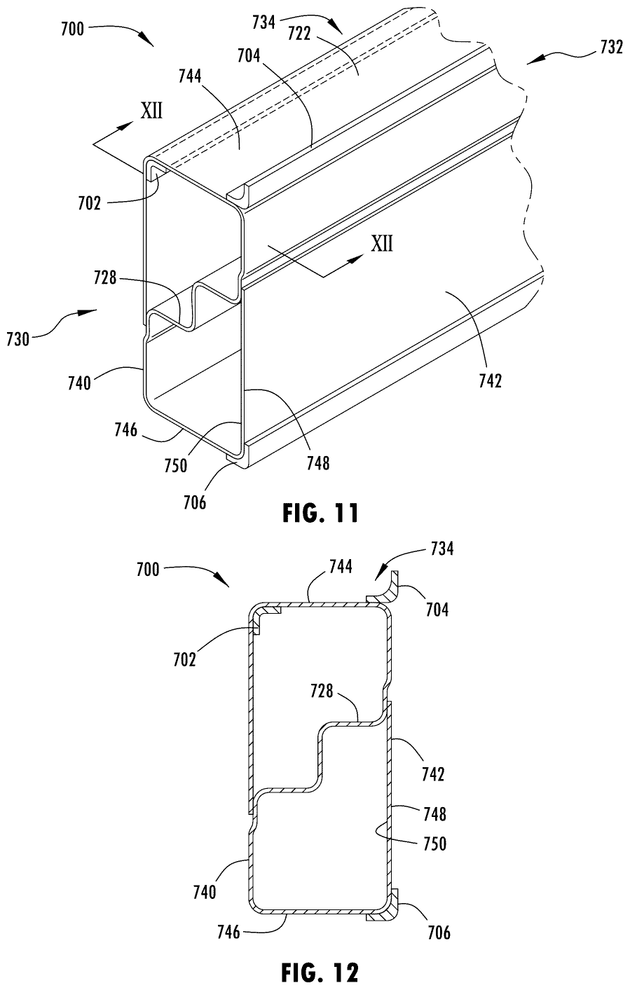

Referring to FIGS. 11 and 12, an exemplary front rail 700 is shown having a sixth exemplary crash tuning feature, namely, reinforcement brackets in corners of the rail. The sixth crash tuning feature comprises a reinforcement section, or a variety of reinforcement sections 702, 704, 706 at various locations along the length of the rail 700. The rail 700 may have any number of reinforcement sections along the length of the rail, including, but not limited to, at least one of a first reinforcement section 702, a second reinforcement section 704, or a third reinforcement section 706. The reinforcement sections 702, 704, 706 may be configured as brackets in corner sections of the rail 700. The reinforcements section 702, 704, 706 may be made of the same material as a sheet material of the rail 700 or may be comprised of a different material.

The first reinforcement section 702 may be positioned in an inner corner of the rail 700, such as shown in FIG. 12 at that the first reinforcement section 702 in inside the cross-section of the rail 700. In the illustrated example, the first reinforcement section 702 is positioned in the corner where a top wall portion 744 and a first side wall portion 740 meet. The reinforcement section 702, as shown in FIG. 12, is configured as an L-shaped bracket extending from the inside of the top wall portion 744 to the inside of the first side wall portion 740. The reinforcement section 702 has a length that extends along the length of the rail 700. In other embodiments, the reinforcement section 702 may have a shorter length and be positioned only in a localized area of the rail 700. While the illustrated first reinforcement section 702 is positioned at the corner of the top wall portion 744 and the first side wall portion 740, additional reinforcement sections may be positioned along any of the inner corners of the cross-sections where added reinforcement and strength is desired. The rail 700 may have a plurality of first reinforcement sections positioned along the length of the rail.

As also shown in FIG. 12, the second reinforcement section 704 may be positioned in an outer corner of the rail 700, such that the second reinforcement section 704 is positioned outside of the cross-section of the rail 700. In the illustrated example, the first reinforcement section 704 is positioned on the outside of the rail at the corner where a second side wall portion 742 and the bottom wall portion 746 meet. The second reinforcement section 704 may be configured as an L-shaped bracket extending from the outside of the second side wall portion 742 to the outside of the bottom wall portion 746. The second reinforcement section 704 has a length that extends along the length of the rail 700. In other examples, the second reinforcement section may have a shorter length and be positioned in a localized area of the rail. Additional second reinforcement sections may be positioned in other areas along the length of the rail. For example, additional second reinforcement sections may be positioned along any of the outer corners of the rail where added reinforcement or strength is desired.

The third reinforcement section 706, such as shown in FIG. 12, may be positioned on an outer corner of the rail 700 and configured as a flange extending from the rail 700. In the illustrated example, the third reinforcement section 706 is positioned on the outside of the rail 700 at the corner of the top wall portion 704 and the second side wall portion 742. However, unlike the second reinforcement section 704, the third reinforcement section 706 is configured as a L-shaped bracket which extends along one wall portion and then extends outward from the rail 700 as a flange. As illustrated, the third reinforcement section 706 extends along the top wall portion 744 and then extends upward from the top wall portion 744. In other embodiments, the third reinforcement section may extend along a different wall portion of the rail or extend in a different direction from the rail. The third reinforcement section 706 may be provided as a flange to reinforce the rail 700 while attaching the rail 700 to a different component, for example, a shock tower (not shown). The third reinforcement section 706 may have a length such that the section 706 extends along a localized length of the rail 700. In other embodiments, the third reinforcement section may extend along the entire length of the rail. The rail 700 may have a plurality of third reinforcement sections positioned along the length of the rail.

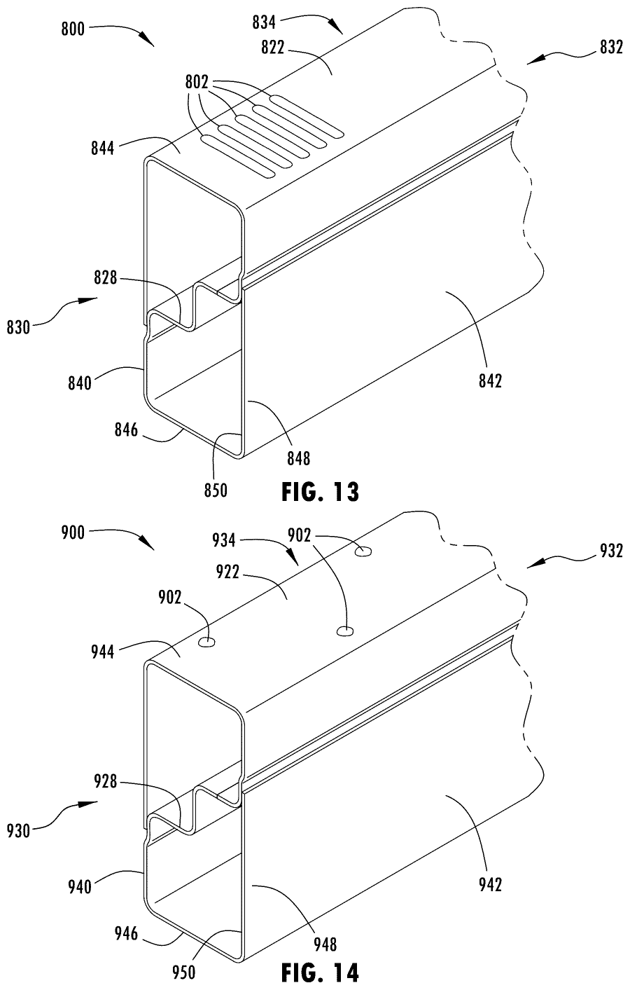

Referring to FIG. 13, an exemplary front rail 800 includes a seventh crash tuning feature comprises a plurality of spot-welds 802 located along the length of the rail 800, 900 which are configured to act as crush initiators. As illustrated in FIG. 13, spot welds 802 may be created along the leading edge 830 of the rail 800 on a top wall portion 844. Providing spot welds 802 on the rail acts as a source of localized heating to the sheet metal 822 of the rail 800 along the welds 802. Heating of the sheet metal 822 creates a zone of reduced hardness, thus forming spots where deformation of the rail 800 is increased upon certain impact forces. As illustrated in FIG. 13, the spot welds 802 are configured as parallel lines along the leading edge. Reduced strength at these locations may cause an accordion-like crushing to occur upon front impact forces. As illustrated in FIG. 14, an exemplary front rail 900 includes an eighth crash tuning feature comprises a plurality of spot-welds 902 along opposite sides of a top wall portion 844 of the rail 800, such as in an alternating arrangement. Heating of the sheet metal 922 at the spot welds 902 reduces strength at these locations, which may cause a z-shaped bending to occur upon front impact forces. In other examples, a rail may include a variety of weld spots at locations where deformation of the front rail is desired upon certain impact forces. The spot welds may be MIG welds formed after the rail is roll-formed. In other examples, the spot welds may be laid from other methods such as laser welding.

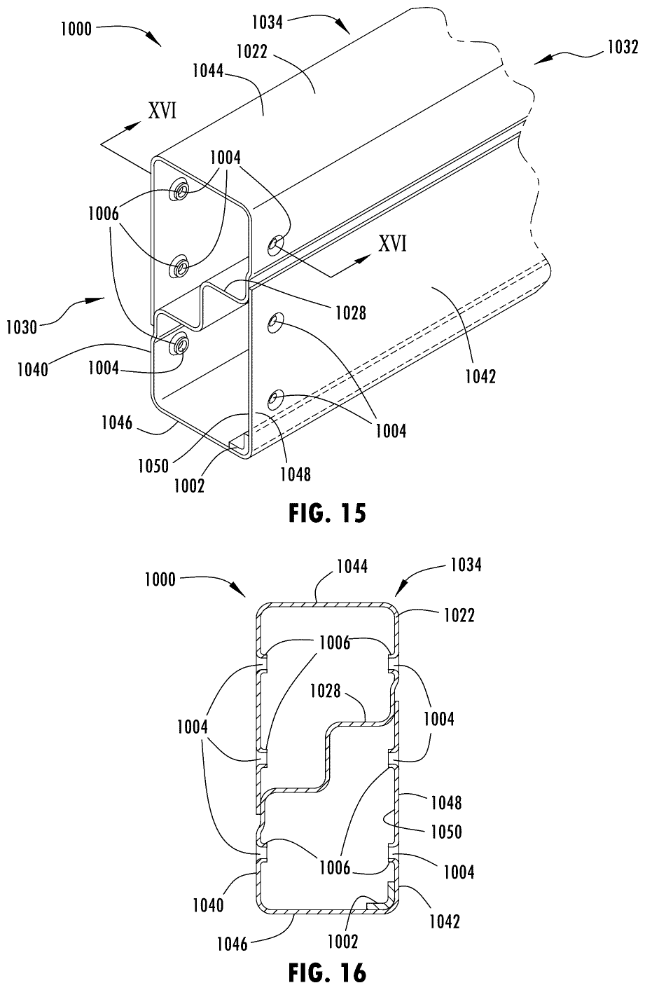

Referring to FIGS. 15 and 16, an exemplary rail 1000 may include any combination of the above described crash tuning features. For example, the rail 100 may include a reinforcement section as described and illustrated in FIGS. 11 and 12 in combination with a plurality of flanged apertures as described and illustrated in FIGS. 5 and 6. As illustrated in FIGS. 15 and 16, the rail 1000 includes a first reinforcement section 1002 configured as a L-shaped bracket positioned in the inner corner of a bottom wall portion 1046 and a second side wall portion 1042 and provides additional stability to the rail 1000 at its location. The reinforcement section 1002 is configured to reduce deformation at the location of said section 1002 and force deformation elsewhere along the rail 1000.

The rail 1000 also includes a plurality of apertures 1004 in the sheet metal 1022 of the rail 1000. As described above with regard to the apertures of FIGS. 5 and 6, the apertures 1004 extend through the sheet material 1022 from an outer surface 1048 of the sheet metal 1022 to an inner surface 1050 of the sheet metal 1022. The apertures 1004 include a flange 1006 on the inner surface of the sheet material 1022 which extends into the cross-section of the rail 1000. The apertures 1004 may be positioned in a vertical line B2 to create a deformation line. In other example, the apertures may be positioned in other locations around the rail 1000 in preferred deformation zones. The apertures 1004 are configured to create a location of reduced strength in the rail 1000, thereby causing a deformation at the location of the apertures 1004 under certain impact forces. In the illustrated example, the reinforcement section 1002 may be configured to strength the immediate leading edge of the rail 1000 where the rail 1000 may connect to a bumper (not shown), and work in conjunction with the plurality of apertures 1004 to force deformation to occur past the immediate leading edge at the location of apertures 1004. Additional combinations of the exemplary crash tuning features may be used to create preferred deformation patterns.

Unless specified to the contrary, it is generally understood that additional implementations of front rail may have an alternate orientation from the examples shown and described, such as where the structure is used as a rear rail, or a side support structure. The front rail may be implemented in other alternative configurations, such as a mirror image to the structure as illustrated.

It is also contemplated that the structure of the disclosed front rails may be incorporated in other types of structural beams, such as in frames and structures of automotive and marine vehicles, buildings, storage tanks, furniture, and the like. With respect to vehicle applications, the vehicle component disclosed herein may be incorporated with various applications of different structural components. The vehicle component may be designed to support and sustain different loading conditions, such as for supporting certain horizontal spans or axial loading conditions. Also, the vehicle component may be designed to undergo various impact forces, such as for the illustrated front impacts, as well as side or rear impacts. The cross-sectional geometry, material type selections, and material thickness within the cross-sectional profile of the vehicle component may be configured for such a particular use and the desired loading and performance characteristics, such as the weight, load capacity the beam, force deflection performance, and impact performance of the vehicle component.

For purposes of this disclosure, the articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional implementations that also incorporate the recited features. Furthermore, the terms “first,” “second,” and the like, as used herein do not denote any order, quantity, or importance, but rather are used to denote element from another.

Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. For example, the terms “approximately,” “about,” and “substantially” may refer to an amount that is within less than 5% of, within less than 1% of, within less than 0.1% of, and within less than 0.01% of a stated amount.

Further, it should be understood that any directions or reference frames in the preceding description are merely relative directions or movements. For example, the terms “upper,” “lower,” “right,” “left,” “rear,” “front,” “vertical,” “horizontal,” “inboard,” “outboard” and derivatives thereof shall relate to the orientation shown in FIG. 1. However, it is to be understood that various alternative orientations may be provided, except where expressly specified to the contrary. It is also to be understood that the specific devices and processes illustrated in the attached drawings, and described in this specification are simply exemplary embodiments of the inventive concepts defined in the appended claims. Hence, specific dimensions and other physical characteristics relating to the embodiments disclosed herein are not to be considered as limiting, unless the claims expressly state otherwise.

Changes and modifications in the specifically described embodiments may be carried out without departing from the principles of the present invention, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A front rail for a vehicle frame, the front rail comprising:
a tubular beam comprising a high-strength metal sheet formed along a length to define a cross-sectional shape that generally extends the length of the tubular beam;
wherein the tubular beam has a front end configured to couple with a bumper assembly and a rear end opposite the front end and configured to couple to a mid-frame component; and
wherein the tubular beam comprises at least one crash tuning feature on the metal sheet configured to undergo deformation during axial loading in a frontal vehicle impact between the front and rear ends.

2. The front rail of claim 1, wherein the cross-sectional shape defines an enclosed shape comprising a first side wall portion, a second side wall portion, a top wall portion, and a bottom wall portion.

3. The front rail of claim 2, wherein the cross-sectional shape includes a central wall extending from a first vertical location at the first side wall portion to a second vertical location at the second side wall portion.

4. The front rail of claim 1, wherein the tubular beam is formed by roll-forming the metal sheet.

5. The front rail of claim 1, wherein the at least one crash tuning feature on the metal sheet comprises an aperture extending through the metal sheet.

6. The front rail of claim 5, wherein the aperture includes a flange surrounding the aperture along an inner surface of the metal sheet.

7. The front rail of claim 1, wherein the at least one crash tuning feature on the metal sheet comprises a plurality of apertures extending through the metal sheet and aligned in a vertical line proximate the front end of the tubular beam.

8. The front rail of claim 1, wherein the metal sheet comprises a first material thickness generally along the length of the tubular beam, and wherein in at least one location along the length of the tubular beam, the at least one crash tuning feature on the metal sheet comprises a second material thickness of the metal sheet.

9. The front rail of claim 1, wherein the at least one crash tuning feature on the metal sheet comprises at least one curved region along the length of the beam.

10. The front rail of claim 9, wherein the at least one curved region comprises a curve in at least one of an outboard or an inboard direction.

11. The front rail of claim 1, wherein the at least one crash tuning feature on the metal sheet comprises at least one reinforcement bracket extending along the length of the tubular beam.

12. The front rail of claim 11, wherein the at least one reinforcement bracket is positioned in in at least one of an inner corner of the cross-sectional shape or an outer corner of the cross-sectional shape.

13. The front rail of claim 1, wherein the at least one crash tuning feature on the metal sheet comprises at least one weld spot on an outer surface of the metal sheet.

14. The front rail of claim 1, wherein the tubular beam includes a plurality of crash tuning features along the length of the beam.

15. A structural beam for a vehicle, the structural beam comprising:
an elongated body formed from a metal sheet material and configured to extend from a first end at a bumper assembly to a second end at a mid-frame assembly;
wherein the elongated body includes a plurality of crash tuning areas formed on the metal sheet material which define areas of reduced strength of the elongated body.

16. The structural beam of claim 15, wherein the crash tuning areas are configured to undergo deformation during axial loading in a frontal vehicle impact between the first end and the second end of the elongated body.

17. A front rail configured to be supported by a vehicle frame, the front rail comprising:
a tubular body formed by a roll-formed high-strength metal and defining a cross-sectional shape along a length of the tubular body; and
at least one crash tuning feature located on the tubular body;
wherein the tubular body is configured to undergo axial loading during a frontal vehicle impact, and
wherein, under axial loading, the tubular body is configured to deform at the at least one crash tuning features.

18. The front rail of claim 17, wherein the at least one crash tuning feature includes a plurality of apertures in the high-strength metal, and the apertures include a flange around the circumference of the aperture on an inner surface of the high-strength metal.

19. The front rail of claim 17, wherein the at least one crash tuning feature includes a plurality of designated locations along the tubular body where the high-strength metal has been weakened, and wherein the high-strength metal has been weakened at the designated locations by at least one of a thinning of the metal, heating of the metal, or welding of the metal at said locations.

20. The front rail of claim 17, wherein the at least one crash tuning feature includes a curve in the tubular body.
